(19) United States
(12) Patent Application Publication
(10) Pub. No.: US 2023/0081525 A1
(43) Pub. Date: Mar. 16, 2023

(54) NON-DAIRY, NON-CURDLING CHICKPEA-BASED MILK SUBSTITUE AND METHOD THEREOF

(71) Applicant: CHKP FOOD INNOVATION LTD., SAVYON (IL)

(72) Inventors: Noam SHARON, Savyon (IL); Asaf COHEN JONATHAN, Nahariya (IL); Noam DEKKERS, Tel Aviv (IL)

(21) Appl. No.: 17/918,354

(22) PCT Filed: Apr. 22, 2021
(86) PCT No.: PCT/IL2021/050467

§ 371 Date: Oct. 12, 2022

Related U.S. Application Data
(60) Provisional application No. 63/014,144, filed on Apr. 23, 2020.

(51) Int. Cl. A23L 11/60; A23L 9/20; A23L 29/231; A23L 2/66; A23L 2/46

(52) U.S. Cl. CPC A23L 11/60; A23L 9/24; A23L 29/231; A23L 2/66; A23L 2/46; A23V 2002/00

(57) ABSTRACT

The present invention provides a non-dairy, chickpea-based alternative milk. More particularly, the present invention discloses a barista milk alternative comprising chickpea isolate. Said milk alternative does not exhibit curdling when used to making coffee, is highly nutritious and resembles bovine milk in terms of organoleptic properties. Additionally, the present invention provides a method for producing a non-dairy, chickpea-based barista milk alternative, which does curdle when used to making coffee.

### FIELD OF THE INVENTION

The present disclosure relates to the plant-based alternative foodstuffs and beverages field, more particularly, the present disclosure concerns a barista milk alternative produced from chickpea protein isolate.

### BACKGROUND OF THE INVENTION

The plant-based non-dairy alternatives market has been rapidly growing in recent years and it is gaining more attention, as more people change their dietary habits and minimize their consumption of animal-based products due to health-related (lactose sensitivity), environmental, economic or ethical reasons (see “Plant-based Milks: A Review of the Science Underpinning Their Design, Fabrication, and Performance”, McClements D. J et al. Comprehensive Reviews in Food Science and Food Safety, Institute of Food Technologists, Vol.18, 2019). A study conducted by Oxford University and the Swiss agricultural research institute, Agroscope, in 2018 estimated that any plant-based choice is better for the earth than dairy, and that the production of one glass of dairy results in almost three times more greenhouse gas emissions than any kind of vegan milk alternative (see “Reducing food's environmental impacts through producers and consumers”, Poore, J, and Nemecek, T., Science 360, 987-992, 2018).

Among the milk alternatives presently available on the market are beverages made mainly of almond, soy, coconut, cashew, quinoa, oat, rice and pea. Nevertheless, most plant-based milk substitutes fail to fully equal bovine milk in terms of nutritional values (such as protein, calcium and vitamins) and physicochemical and sensory properties (such as consistency, mouthfeel and appearance). One of the major issues concerning plant-based milk analogues is their light consistency and their protein content, which tends to result in increased curdling (coagulation), i.e. the breaking of emulsions or colloids to different compositions by flocculation, creaming, and coalescence. Curdling occurs when proteins found in plant-based milk analogues coagulate when they come into contact with the acids in the coffee. This chemical reaction is highly noticeable and attributable to the large temperature difference between the hot coffee and the cold non-dairy milk alternative. The hotter the coffee is, less acid is needed to coagulate the plant proteins and the curdling reaction is thus, accelerated. In addition to temperature and acidity, different ions, molecules and enzymes can result in curdling as well. Dairy milk on the other hand does not curdle in coffee despite the temperature differences because of its pH value, low acidity and calcium content.

Chickpea (Cicer arietinum) is an interesting and novel candidate for producing plant-based milk alternatives. Chickpea is an annual legume, referred to as a pulse crop (a crop harvested for its edible seeds), which is naturally enriched with nutritional values, some of which surpass other plants commonly used for the production of plant-based milk alternatives.

EP patent 3285596A4 discloses a non-dairy substitute which can be produced from comparatively high starch legumes, such as chickpeas and adzuki beans. In some examples, the non-dairy substitute is produced by hydrating the high starch legumes, remove excess water, and then heating the hydrated high starch legumes in the presence of water and amylase at a controlled pH to reduce the starch content of the legumes. The slurry of reduced starch content can then be filtered to remove insoluble fiber and suspended soluble fiber present in the legume slurry, producing a non-dairy “milk” that can be used in a variety of products. In different examples, the legume “milk” is cultured with the addition of bacterial cultures to form a cheese or yogurt and/or formed into a non-dairy ice cream. In any application, an acidifying ingredient such as citric acid may be added to the product. This can help reduce or eliminate residual legume flavor.

US patent 20190320689 discloses a “ready-to-drink” beverage comprising a significant amount of complete protein per 8 fluid-ounce serving, the proteins derived from a plant protein blend comprising a legume protein, a whole grain protein, and a dairy or wheat protein. Other components added include a sweetening component, a flavor component, hydrocolloids, and optionally maltodextrin to produce a ready-to-drink beverage with no visible sedimentation and good taste and mouthfeel. The components are subjected to a high temperature treatment step, followed by a homogenizing step. Formulations provide for source of high quality, complete protein.

Patent application WO 2018/191629 discloses a plant-based milk alternative composition useful in various food and beverage products that approximates the nutritional and functional properties of dairy milk but does not contain dairy or lactose.

In view of the prior art and given the challenges described above, there is still an unmet long-felt need to provide a barista milk analogue composed of plant protein, which is high in nutritional values, resembling dairy milk in terms of organoleptic properties, and most importantly, does not exhibit curdling when used to making coffee.

### BRIEF DESCRIPTION OF THE FIGURES

The accompanying drawings, which are included to provide a further understanding of the invention and are incorporated in and constitute a part of this specification, illustrate embodiments of the invention and together with the description serve to explain the principles of the invention.

FIG. 1 schematically depicts a flowchart of the different steps required for producing the chickpea-based barista milk alternative of the present invention.

### SUMMARY OF THE INVENTION

It is one object of the present invention to disclose a beverage comprising chickpea isolate of at least about 80% protein and pectin, wherein said beverage does not exhibit curdling.

It is another object of the present invention to disclose a chickpea-based milk alternative comprising:
a. chickpea isolate of between about 1.5% to about 5%;
b. predetermined volume of water;
c. at least one deodorized plant fat of between about 0% to about 10%;
d. pectin of between about 0.3% to about 1%;
e. at least one stabilizer; and
f. at least one food additives of between about 0% to about 15%, wherein, said chickpea-based milk alternative does not exhibit curdling.

It is another object of the present invention to disclose the chickpea-based milk alternative of the above, wherein said chickpea isolate comprises at least about 80% protein.

It is another object of the present invention to disclose the chickpea-based milk alternative of the above, wherein said chickpea isolate comprises all the essential amino acids required for human diet.

It is another object of the present invention to disclose the chickpea-based milk alternative of the above, wherein said deodorized plant fat is selected from a group consisting of coconut, sunflower, sesame, cotton, avocado, grapeseed, nigella seeds and any combination thereof

It is another object of the present invention to disclose the chickpea-based milk alternative of the above, wherein said pectin is a pectin characterized in esterification degree of at least about 50%. It is another object of the present invention to disclose the chickpea-based milk alternative of the above, wherein said pectin is derived from a group consisting of sugar beet, pear, potato, spinach, beans, pumpkin and any combination thereof. It is another object of the present invention to disclose the chickpea-based milk alternative of the above, wherein said at least one stabilizer is selected from a group consisting of gellan gum, methyl cellulose, kappa carrageenan, iota carrageenan and any combination thereof.

It is another object of the present invention to disclose the chickpea-based milk alternative of the above, wherein said at least one food additive is selected from a group consisting of stabilizers, anticaking agents, antifoaming agents, antioxidants, bulking agents, colorants, emulsifiers, flavoring agents, humectants, preservatives, sweeteners, sugars, starches, minerals, proteins, vitamins, hydrocolloids, thickeners and any combination thereof.

It is another object of the present invention to disclose the chickpea-based milk alternative of the above, wherein said milk alternative is a barista milk, configured to be used for coffee making.

It is another object of the present invention to disclose the chickpea-based milk alternative of the above, wherein said curdling occurs in circumstances selected from a group consisting of: contact with hot fluids, contact with cold fluids, contact with acidic fluids, contact with alkaline fluids, heating, cooling or any combination thereof.

It is another object of the present invention to disclose a method for producing a chickpea-based milk alternative comprising steps of:
a. adding chickpea isolate powder to pectin;
b. stirring at about at least 1500 RPM;
c. adding at least one deodorized plant fat at about 50° C.;
d. stirring at about 1500 RPM;
e. adding at least one stabilizer and at least one food additive;
f. homogenizing all ingredients for at least about 2 minutes to create a beverage; and
g. pasteurizing said beverage.

It is another object of the present invention to disclose the method of the above, wherein said chickpea isolate comprises at least about 80% protein.

It is another object of the present invention to disclose the method of the above, wherein said pectin is characterized in esterification degree of at least about 50%.

It is another object of the present invention to disclose the method of the above, wherein said deodorized plant fat is selected from a group consisting of coconut, sunflower, sesame, cotton, avocado, grapeseed, nigella seeds and any combination thereof.

It is another object of the present invention to disclose the method of the above, wherein said homogenizing step is conducted by means selected from a group consisting of mixing at about 10000 RPM or using pressure homogenization.

It is another object of the present invention to disclose the method of the above, wherein said at least one stabilizer is selected from a group consisting of gellan gum, methyl cellulose, kappa carrageenan, iota carrageenan and any combination thereof.

It is another object of the present invention to disclose the method of the above, wherein said at least one food additive is selected from a group consisting of stabilizers, anticaking agents, antifoaming agents, antioxidants, bulking agents, colorants, emulsifiers, flavoring agents, humectants, preservatives, sweeteners, sugars, starches, minerals, proteins, vitamins, hydrocolloids, thickeners and any combination thereof.

### DETAILED DESCRIPTION OF THE PREFERRED EMBODIMENTS

The following description is provided, alongside all chapters of the present invention, so as to enable any person skilled in the art to make use of the invention and sets forth the best modes contemplated by the inventor of carrying out this invention. Various modifications, however, are adapted to remain apparent to those skilled in the art, since the generic principles of the present invention have been defined specifically to provide a chickpea-based barista milk alternative and method thereof.

As used herein after, the term “about” refers to any value being up to 25% lower or greater than the defined measure.

As used herein after, the term “dairy milk” refers to milk derived from an animal origin, such as cows, goats, sheep, camels etc.

As used herein, the term “plant-based/non-dairy milk analogue/alternative/substitute” refers to any consumable vegan beverage made with plant-based ingredients, and is supposed to mimic the appearance, taste, odor or texture of similar products of animal origins (dairy milk). This beverage can replace dairy milk when it comes to making coffee, ice cream, desserts, pastries, pasta dishes etc.

As used herein, the term “chickpea-based barista milk alternative” refers to the product of the present invention. It concerns a vegan beverage, maid mainly from chickpea, and it can be consumed and used as a replacement for dairy milk.

As used herein, the term “barista milk” refers to beverages specially formulated to be used for making coffee.

As used herein, the term “chickpea” refers to an annual plant (Cicer arietinum) belonging to the Fabaceae family. In the context of the present application, any variety of chickpea (cultivated, wild type, hybrid, product of genetic or molecular engineering etc.) can be used to make the non-curdling barista milk alternative disclosed herein.

As used herein, the term “chickpea isolate” refers to a chickpea powder consisting a protein content (by weight) higher than 80%, which is processed to reduce levels of fats and carbohydrates.

As used herein, the terms “high ester pectin” or “sugar ester” refer to polysaccharides that are rich in galacturonic acid units, which are highly esterified. Preferably, these types of pectin also contain acetyl groups. In the context of the present invention, the combination of the chickpea isolate and these unique high ester pectins leads to chemical reactions which keep the barista milk alternative from curdling when in contact with hot of acidic fluids. As it appears, the highly esterified pectins interact with the proteins found in the chickpea isolate, thus, altering the amino acids' electric charges, keeping protein molecules from interacting among themselves and aggregating.

As used herein, the term “curdling” refers to the coagulation of proteins when they undergo denaturation and aggregate. This phenomenon can occur due to environmental changes such as acidity, hot temperature, radiation, shear forces etc. These environmental changes lead to the formation of protein clumps or aggregates, appearing as white spots floating and spiraling in the beverage. This phenomenon is highly typical to vegan, plant-based milk alternatives used for the preparation of coffee.

As used herein, the term “non-curdling” refers to the ability of the plant-based barista milk alternative of the present invention to remain homogenous and intact when in contact with hot or acidic fluids (such as coffee or water) and not break down to aggregates.

As used herein, the term “organoleptic properties” refers to the numerous aspects of foodstuffs, beverages or other substances that create an individual sensory experience such as taste, sight, smell, texture, mouthfeel or touch. In the context of the present invention, the plant-based barista milk alternative has organoleptic properties which are similar and highly resemble dairy milk. In other words, the product of the present invention looks like dairy milk due to its white color, tastes like dairy milk and does not exhibit any unpleasant aftertaste or taste or odor characteristic of chickpea or its derivatives (such as hummus). Moreover, due to the unique composition of the barista milk alternative of the present invention, it physiochemically behaves like dairy milk when in contact with hot water or hot coffee by not curdling or creating aggregates.

As used herein, the term “nutritional values” refers to the measure of essential nutrients, such as fats, proteins, carbohydrates, minerals and vitamins in foodstuffs and beverages. The non-curdling, plant-based barista milk alternative of the present invention is enriched with protein, vitamins and minerals, as it is made of chickpea, one of the most nutritious legumes consumed. Moreover, as the product of the present invention is completely plant-based and does not contain any dairy milk, it is also devoid of certain potentially negative or harmful nutritional components of dairy milk, such as lactose, to which 30%-60% of the global population is intolerant to some extent (especially in Eastern Asia, Africa and Latin America), or allergenic proteins, which sometimes can result in fatal consequences.

As used herein, the term “essential amino acids” refers to the amino acids that a human cannot synthesize and must consume from external sources. These amino acids are: phenylalanine, valine, threonine, tryptophan, methionine, leucine, isoleucine, lysine, and histidine. Amino acid deficiency is a severe medical condition caused by an under-consumption of amino acids, manifesting in a variety of symptoms and pathologies, such as muscle weakness, digestive problems, mental problems, fertility issues and more. The chickpea-based barista milk alternative of the present invention is highly nutritious and rich in essential amino acids.

The present invention provides a product which is a chickpea-based milk alternative, mainly destined for making coffee. This milk alternative comprises a chickpea isolate powder, which is characterized by having 80% or more protein content. In addition, the disclosed product is highly similar to dairy milk in terms of color and organoleptic properties, it lacks the characteristic taste of chickpea, it has favorable nutritional values (essential amino acids, vitamins and minerals), and most importantly, it does not exhibit curdling when it comes in contact with hot or acidic fluids (such as hot water and coffee), thus, the experience of drinking coffee remains pleasant and uncompromised. The present invention also provides a method for producing the chickpea-based barista milk alternative.

As previously mentioned, the market of vegan plant-based milk alternatives is rapidly expanding. Among the milk alternatives presently available are beverages made mainly of almond, soy, coconut, cashew, quinoa, oat, rice and pea. Nevertheless, these milk substitutes usually fail to fully equal dairy (bovine) milk in terms of nutritional values (such as protein, calcium and vitamins) or mimic the organoleptic characteristics (such as consistency, mouthfeel and appearance) of animal-based milks. One of the major issues concerning plant-based milk analogues is their light consistency and their protein content, which tends to result in increased curdling (coagulation), i.e. the breaking of emulsions or colloids to different compositions by flocculation, creaming, and coalescence. Curdling occurs when proteins found in plant-based milk analogues coagulate when they come into contact with the acids in the hot coffee. Curdling usually manifests as white sludgy spots or filaments in the beverage, rendering its appearance and texture unsmooth and therefore, unappealing. It is highly important to note that many vegan consumers or those who wish to reduce their dairy consumption are deterred by milk alternatives due to the curdling issue. Several articles, online blogs and tasting surveys from recent years which cover the plant-based milk alternatives conclude that many products, including commercial almond milk, hazelnut milk, pea milk, cashew milk and soy milk are highly prone to curdling, to having unpleasant or peculiar aftertastes or to lacking essential nutritional values. (see for example “www. chatelaine.com/food/vegan-milks-coffee-canada/”, “www. ravecoffee.co.uk/pages/best-non-dairy-milk-for-coffee”, “www. sevenmiles.com.au/editorial/milk-alternatives-for-coffee/” and “www.highspeedtraining.co.uk/hub/best-alternative-to-milk/”).

To solve those issues, coffee experts suggest to let the coffee temperature cool down before pouring the milk, or alternatively warm the milk a little bit before stirring it with the coffee, or to use low-acid coffee brands. However, the present application aims at solving these technical challenges by providing a non-curdling, highly nutritious plant-based barista milk alternative, which does not require pre-adjusting the milk or the coffee temperatures or to settle for specific coffee brands.

As previously disclosed, the plant-based barista milk alternative is made of chickpea isolate. Chickpea is an excellent candidate for production of foodstuffs and beverages. It is enriched with proteins (2-3 times higher than cereal grains), soluble dietary fibers, resistant starch, vitamins (B1, B2, B3, B5, B6, B9, B12, C, E and K), and minerals (calcium, iron, magnesium, copper, manganese, phosphorus, potassium and zinc) [see “The Nutritional Value and Health Benefits of Chickpeas and Hummus”, Taylor C. Wallace et al, Nutrients 2016, 8, 766, and “Nutritional Value of Chickpea”, J. A. Wood & M. A. Grusak, Chickpea Breeding and Management, Chapter 5, p. 101-142, CAB International, 2007]. Therefore, daily consumption of chickpea-based foodstuffs and beverages could be beneficial for human health, minimizing incidence of multiple nutrition deficiencies and medical conditions such as kwashiorkor, metabolic disorders, and skeletal muscle disorders. Furthermore, chickpea can replace dairy products in one's diet completely or partially, as it is rich in protein and other nutritional values, and does not lead to medical conditions involving lactose intolerance.

In a preferred embodiment of the present invention, the chickpea protein used to produce the disclosed barista milk alternative is a chickpea isolate, which is characterized by more than 80% protein.

In yet another preferred embodiment of the present invention, the chickpea isolate used to produce the disclosed barista milk alternative comprises complete protein, meaning it contains all the nine essential amino acids necessary for human diet, which mammalian subjects cannot synthesize by themselves. These amino acids are as follows: phenylalanine, valine, threonine, tryptophan, methionine, leucine, isoleucine, lysine, and histidine. In addition, the disclosed chickpea isolate comprises cysteine, aspartic acid, serine, glutamic acid, proline, glycine and alanine.

In another preferred embodiment of the present invention, the disclosed chickpea-based barista milk alternative is characterized by organoleptic properties, rendering it similar to dairy milk. The color of the disclosed barista milk alternative is white, highly resembling dairy milk. In addition, the disclosed barista milk alternative does not taste or smell like chickpea. The chickpea-based barista milk alternative comprises flavoring agents which confer it with its distinct taste. These flavors, can be, but are not limited to, dairy flavors produced by known manufactures in this particular field, such as EDLONG, IFF Inc., GIVAUDAN, FRUTAROM, FIRMENICH etc.

In another preferred embodiment of the present invention, the disclosed chickpea-based barista milk alternative is composed of such ingredients and produced in such manner that the barista milk alternative does not exhibit curdling at all when used to making coffee.

In an additional preferred embodiment of the present invention, the disclosed chickpea-based barista milk alternative of the present application contains pectin for its emulsifying and emulsion-stabilizing properties. In a non-limiting example, the pectin is a high ester pectin (sugar ester) extracted for example, from sugar beet pulp, pears, pumpkin or potatoes. This type of pectin is enriched with hydrophilic and hydrophobic regions, and is characterized by an esterification degree of at least about 55%. Different types of high ester pectin can be employed to formulate the chickpea-based barista milk alternative of the present invention. The pectin used in the disclosed product can contain, beside the methyl esters groups, acetylated units of galacturonic acid, and it can be referred to as high-acetyl esterified pectin. It is believed that these chemical structures increase the stabilizing and emulsifying properties of the pectin. Without wishing to be bound by theory, it is likely that the acetyl groups and the esters create hydrophobic interactions with the amino acid of the chickpea isolate powder, by keeping water molecules from binding to the polysaccharides, thus rendering them more available to bind to the chickpea proteins.

The high ester pectin which can be used to formulate the disclosed barista milk alternative is preferably flavorless and non-allergenic, capable of providing stable oil-in-water emulsions and keeping pulp particles in suspension. Moreover, the high ester pectin creates more stable emulsions at half the use level of other similar ingredients such as propylene glycol alginate, and it is experimentally proven to result in a lower viscosity and a lighter mouthfeel compared to other emulsifiers. In addition, the high ester pectin that can be used to formulate the chickpea-based barista milk alternative has a long shelf life of 12-24 months, allowing it to remain stable throughout the life of the disclosed beverage, and keeping it from curdling for prolonged periods.

The high ester pectin binds to the chickpea proteins in the isolate, keeping them apart from each other, thus minimizing the likelihood of protein to bind to each other and to coagulate (hence, curdling is avoided, when the barista milk alternative of the present invention comes in contact with hot coffee).

In additional preferred embodiment of the present invention, the disclosed chickpea-based barista milk alternative comprises at least one plant fat, preferably, deodorized plant fats. Those fats can be selected in a non-limiting way from: coconut, sunflower, sesame, cotton, avocado, grapeseed, nigella seeds, and any additional plant fats known in the art.

In additional preferred embodiment of the present invention, the disclosed chickpea-based barista milk alternative comprises at least one stabilizer. This stabilizer can be for example, gellan gum, methyl cellulose, kappa carrageenan, iota carrageenan or any other stabilizer used in this field and known to the skilled person. In yet another preferred embodiment of the present invention, the disclosed chickpea-based barista milk alternative comprises at least one food additive. This food additive can be selected for example, from the following ingredients: anticaking agents, antifoaming agents, antioxidants, bulking agents, colorants, emulsifiers, flavoring agents (particularly dairy flavors, meaning vegan flavors mimicking the taste of dairy milk), humectants, preservatives, sweeteners, sugars, starches, minerals, proteins, vitamins, hydrocolloids, thickeners and any other food additives known in this art. In yet another preferred embodiment of the present invention, the pasteurization process of the disclosed chickpea-based barista milk alternative lasts for about 1 minute at about 90° C. or for about 2-10 seconds at about 120° C.-140° C. and then cooling down to about 40° C.

### EXAMPLE 1

### Nutritional Values of the Chickpea-Based Barista Milk Alternative

Reference is now made to the following Tables 1-4 depicting a nutritional analysis of two chickpea isolate powders, each of them has been successfully tested for the production of the disclosed chickpea-based barista milk alternative. As can be seen from the following tables the chickpea isolate powders are rich in minerals (such as magnesium, calcium and ferrous), vitamins (A, B6, C, D and E) and 17 amino acids, 8 of which are considered essential and cannot be synthesized by human subjects.

TABLE 1
Nutritional Analysis of chickpea isolate G910

| | |
|---|---|
| Test | Value |

Proximate Analysis

| | |
|---|---|
| Energy (kcal/100 gr) | 357 |
| Protein (%, on D.M) | 89.1 |
| Moisture (%) | 6.3 |
| Total Carbohydrates (%) | 8.9 |
| Ash (%) | 2.9 |
| Fat (%) | <0.1 |
| Ash (on D.M) (%) | 3.0 |
| Ca (mg/100 gr) | 40 |
| Fe (mg/100 gr) | 22 |
| Mg (mg/100 gr) | 23 |
| Na (mg/100 gr) | 914 |
| Vit B6 (mg/kg) | 71.24 |
| Vit B1 (mg/kg) | Not detected |
| Vit A (IU/100 gr) | <350 |
| Vit C (mg/kg) | <10 |
| Vit D (mg/kg) | 4.88 |
| Vit E (mg/100 gr) | <2.2 |

TABLE 2
Amino Acid Analysis of chickpea isolate G910
Amino Acids Analysis

| | |
|---|---|
| Cysteic acid | 0.93% |
| Aspartic acid | 9.5% |
| Methionine sulfon | 1.12% |
| Threonine | 2.81% |
| Serine | 4.06% |
| Glutamic acid | 14.05% |
| Proline | 3.54% |
| Glycine | 3.12% |
| Alanine | 3.47% |
| Valine | 4.13% |
| Isoleucine | 4.11% |
| Leucine | 6.56% |
| Tyrosine | 2.75% |
| Phenylalanine | 5.22% |
| Lysine | 5.48% |
| Histidine | 2.15% |
| Arginine | 7.63% |
| Total | 80.63% |

TABLE 3
Nutritional Analysis of chickpea isolate G930

| | |
|---|---|
| Test | Value |

Proximate Analysis

| | |
|---|---|
| Energy | 364 kcal/100 gr |
| Protein (%, on D.M) | 89.7 |
| Moisture (%) | 6.1 |
| Total Carbohydrates (%) | 7.0 |
| Ash (%) | 2.9 |
| Fat (%) | <0.1 |
| Ca (mg/100 gr) | 36 |
| Fe (mg/100 gr) | 22 |
| Mg (mg/100 gr) | 20 |
| Na (mg/100 gr) | 854 |
| Vit B6 (mg/kg) | 70.32 |
| Vit B1 (mg/kg) | Not detected |
| Vit A (IU/100 gr) | <350 |
| Vit C (mg/kg) | <20 |
| Vit D (mg/kg) | 5.32 |

TABLE 4
Amino Acid Analysis of chickpea isolate G930
Amino Acids Analysis

| | |
|---|---|
| Cysteic acid | 0.98% |
| Aspartic add | 10.08% |
| Methionine sulfon | 1.18% |
| Threonine | 2.99% |
| Serine | 4.42% |
| Glutamic acid | 14.88% |
| Proline | 3.77% |
| Glycine | 3.23% |
| Alanine | 3.82% |
| Valine | 4.30% |
| Isoleucine | 4.23% |
| Leucine | 6.89% |
| Tyrosine | 2.79% |
| Phenylalanine | 5.60% |
| Lysine | 5.65% |
| Histidine | 2.25% |
| Arginine | 8.02% |
| Total | 85.10% |

Table 5 presents the concentrations of the essential amino acids found in a chickpea isolate powder, that may be used to formulate the chickpea-based barista milk alternative of the present invention, compared to the known average concentrations of other plants used for milk alternatives. The concentrations are presented as gr/110 gr protein.

TABLE 5
Concentrations of Essential Amino Acid of chickpea isolate G930

| | Chickpea | | | | | | | |
|---|---|---|---|---|---|---|---|---|
| | isolate | Chickpea | Soy | Pea | Rice | Corn | Oat | Lupin |
| Histidine | 2.67507 | 2.74266 | 2.65773 | 2.41243 | 2.12195 | 2.41598 | 2.66776 | 2.94521 |
| Lysine | 6.71741 | 6.60449 | 5.88857 | 7.32621 | 3.00381 | 2.32113 | 4.18658 | 4.69588 |
| Leucine | 8.19167 | 7.58918 | 7.08899 | 7.45851 | 7.57929 | 12.41878 | 7.82703 | 6.60902 |
| Isoleucine | 5.02914 | 4.24625 | 4.26587 | 4.20889 | 3.69630 | 3.52372 | 3.99635 | 3.68935 |
| Valine | 5.11236 | 4.20166 | 4.35793 | 4.58093 | 5.13684 | 4.61597 | 6.93149 | 3.56451 |
| Threonine | 3.55487 | 3.51545 | 3.61561 | 3.69833 | 3.29731 | 3.43490 | 3.32465 | 3.23779 |
| Tyrosine | 3.31709 | 2.84985 | 3.45002 | 3.18638 | 4.56591 | 4.67526 | 3.73064 | |
| Phenylalanine | 6.65796 | 5.33788 | 4.72248 | 4.99003 | 4.95331 | 5.33725 | 5.16989 | |
| Cystein | 1.16514 | 1.09120 | 1.18360 | 0.92761 | 1.55608 | 1.35111 | 3.11474 | |
| Methionine | 1.40293 | 1.46963 | 1.25924 | 0.86723 | 2.39643 | 2.06285 | 1.93992 | |
| Tryptophan | 0.82316 | 0.96151 | 1.34211 | 0.90548 | 1.21506 | 0.75582 | 1.59321 | 0.79610 |

As can be seen from Table 5, the chickpea isolate contains all the essential amino acids necessary for a human diet. Some of the concentrations are higher than those found in other plants used for the production of milk alternatives, but as disclosed herein, the proteins of the chickpea isolate of the present invention do not curdle, as opposed to other plant-based proteins, when used to making coffee. Numerous trials have been published online, where tasters tested and compared different types of plant-based milk alternatives for coffee. For instance, a test done by the Canadian website Chatelaine (www.chatelaine.com/food/vegan-milks-coffee-canada/) demonstrated that the tested commercial almond, hazelnut and soy milks tended to curdle when came into contact with coffee and boiling water, and that rice milk and pea milk had significant texture and taste issues. Another test done by High Speed Training (www.highspeedtraining.co.uk/hub/best-alternative-to-milk/) revealed that when it came to making coffee, the tested soy milk, sweetened and unsweetened almond milk and rice milk all exhibited curdling. The chickpea-based barista milk alternative of the present invention does not exhibit any curdling when used to making coffee, due to the unique chickpea protein content and other ingredients of the product, mainly the high ester pectin, which interact with the protein molecules, keeping them from aggregating.

### EXAMPLE 2

To properly evaluate the organoleptic properties of the chickpea-based barista alternative of the present invention in comparison with other similar products (plant-based milk alternatives for coffee), a tasting trial was conducted. The trial included 10 highly trained, qualified and experienced supertasters, filtered according to the ISO sensory analysis standards based on their sensory sensitivity, memory and repeatability and consistency. The chickpea-based barista milk alternative (product 1) was tested and evaluated in comparison with 5 reference products of known Israeli and international companies: lightly sweetened soy milk (2), oat-based alternative barista milk (3), oat-based alternative milk (4), rice milk (5), and almond milk (6). The tasters were asked to select specific descriptive words to describe each product from the following criteria: flavor, texture, mouthfeel, visual elements and odor.

The results of the sensory analysis for these products are presented in Table 6.

TABLE 6
Sensory analysis based on verbal description

| | Product 1 | | | |
|---|---|---|---|---|
| | (chickpea- | | | |
| | based barista | | Product 4 | |
| | milk of the | Product 2 | (oat-based | |
| | present | (sweetened | alternative | Product 5 |
| | invention) | soy milk) | milk) | (rice milk) |
| Descriptive | thick, | yellow- | sweet, | sweet, |
| words | consistent, | looking, | granular | watery, |
| | white, | strong | (grainy), | thin |
| | creamy, | flavor, dark, | mocha-colored, | (light) |
| | shiny | bitter, vanilla | thick, dark, | |
| | | flavored, | metal, sandy | |
| | | astringency | | |

*bold words are the most common words selected by most tasters for each product.

In addition, the tasters were requested to grade the products using a 0-100 scale based on the following characteristics: bitterness, flavor strength and consistency (thickness).

The results of the numerical evaluation of the products are presented in Table 7.

TABLE 7
Sensory analysis based on numerical evaluation

| | Product 1 | Product 2 | Product 3 | Product 5 | Product 6 |
|---|---|---|---|---|---|
| bitterness | 47 | 34 | 26 | 28 | 58 |
| flavor | 63 | 47 | 49 | 44 | 65 |
| strength | | | | | |
| consistency | 84 | 46 | 50 | 17 | 25 |
| total | 194/300 | 127/300 | 125/300 | 89/300 | 148/300 |

As can be seen from Tables 6-7, the trained supertasters found the chickpea-based barista milk alternative of the present invention best suited for making coffee, and gave it the highest scores. The product's texture (consistency) and appearance (white color resembling bovine dairy milk) were praised by the supertasters. Other products, mainly the oat-based beverages tasted granular (grainy), meaning they tend to curdle in the coffee, unlike the product of the present invention. In summary, the combination of thick consistency, color, flavor (bitterness associated with coffee) and non-curdling properties renders the product of the present invention unique and more advantageous compared to other plant-based barista milk alternatives.

### EXAMPLE 3

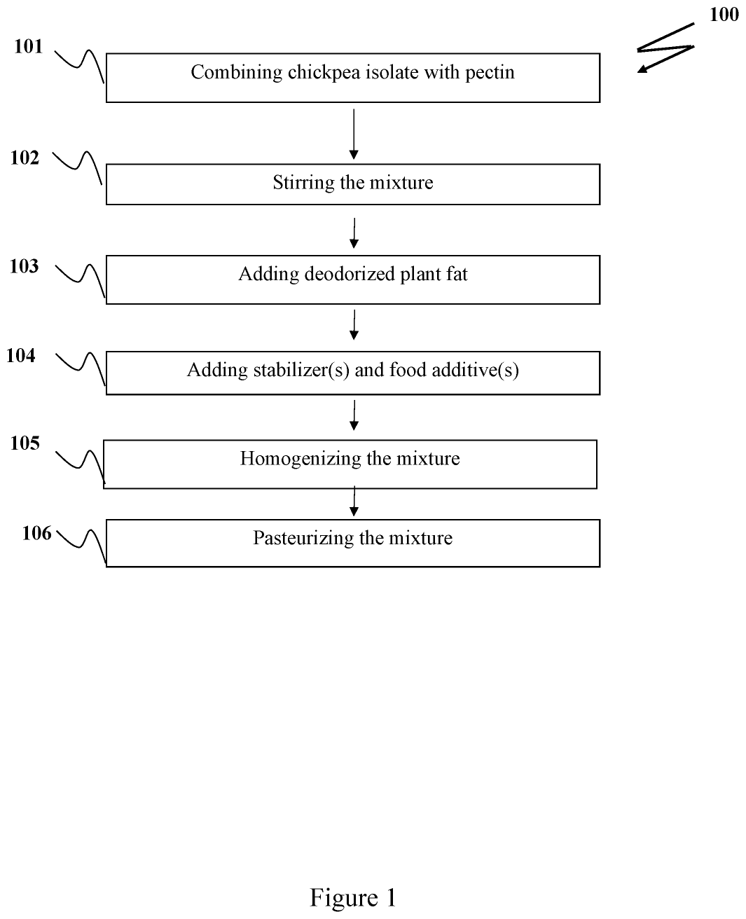

Reference is now made to FIG. 1 graphically presenting the steps of the method of the present invention (100). In order to obtain the non-curdling, chickpea-based barista milk alternative, one can use available pre-dissolved pectin or dissolve and activate the pectin by himself. In order to dissolve pectin, predetermined volume of water is initially added to about 1.5 gr high ester pectin in a mixing tank to activate the pectin. The mixture is boiled to about 85° C. and mixed at about 5,000 RPM. Subsequently, the dissolved pectin is cooled down to about 50° C. The first step of the disclosed method is adding the dissolved pectin to about 10 gr chickpea protein isolate (101). The mixture is then well stirred at about at least 1,500 RPM (102) to ensure incorporation of the protein isolate. Then, about 9 gr of deodorized plant fat (for example coconut fat or sunflower oil) is added at about 50° C. under slow agitation of about 1,500 RPM (103). The following steps require the addition of at least one stabilizer (for instance about 0.075 gr gellan gum) and at least one food additive (for instance dairy flavors) (104) and homogenizing them into the mixture for at least about 2 minutes, either by mixing them at about 10,000 RPM or by using a pressure homogenizer (105). Following homogenization, the mixture is pasteurized for about 1 minute at about 90° C. or for about 2-10 seconds at about 120° C.-140° C. and cooled down to about 40° C. (106).

1. A beverage comprising chickpea isolate of at least about 80% protein and pectin, wherein said beverage does not exhibit curdling.

2. A chickpea-based milk alternative comprising:
a. chickpea isolate of between about 1.5% to about 5%;
b. predetermined volume of water;
c. at least one deodorized plant fat of between about 0% to about 10%;
d. pectin of between about 0.3% to about 1%;
e. at least one stabilizer; and
f. at least one food additive of between about 0% to about 15%,
wherein, said chickpea-based milk alternative does not exhibit curdling.

3. The chickpea-based milk alternative of claim 2, wherein said chickpea isolate comprises at least about 80% protein.

4. The chickpea-based milk alternative of claim 2, wherein said chickpea isolate comprises all the essential amino acids required for human diet.

5. The chickpea-based milk alternative of claim 2, wherein said deodorized plant fat is selected from a group consisting of coconut, sunflower, sesame, cotton, avocado, grapeseed, nigella seeds and any combination thereof.

6. The chickpea-based milk alternative of claim 2, wherein said pectin is characterized by esterification degree of at least about 50%.

7. The chickpea-based milk alternative of claim 2, wherein said pectin is derived from a group consisting of sugar beet, pear, potato, spinach, beans, pumpkin and any combination thereof.

8. The chickpea-based milk alternative of claim 2, wherein said at least one stabilizer is selected from a group consisting of gellan gum, methyl cellulose, kappa carrageenan, iota carrageenan and any combination thereof.

9. The chickpea-based milk alternative of claim 2, wherein said at least one food additive is selected from a group consisting of stabilizers, anticaking agents, antifoaming agents, antioxidants, bulking agents, colorants, emulsifiers, flavoring agents, humectants, preservatives, sweeteners, sugars, starches, minerals, proteins, vitamins, hydrocolloids, thickeners and any combination thereof.

10. The chickpea-based milk alternative of claim 2, wherein said milk alternative is a barista milk, configured to be used for coffee making.

11. The chickpea-based milk alternative of claim 2, wherein said curdling occurs in circumstances selected from a group consisting of: contact with hot fluids, contact with cold fluids, contact with acidic fluids, contact with alkaline fluids, heating, cooling or any combination thereof.

12. A method for producing a chickpea-based milk alternative comprising steps of:
a. combining chickpea isolate with pectin;
b. stirring at about at least 1500 RPM;
c. adding at least one deodorized plant fat at about 50° C.;
d. stirring at about 1500 RPM;
e. adding at least one stabilizer and at least one food additive;
f. homogenizing all ingredients for at least about 2 minutes to create a beverage; and
g. pasteurizing said beverage.

13. The method of claim 12, wherein said chickpea isolate comprises at least about 80% protein.

14. The method of claim 12, wherein said pectin is characterized by esterification degree of at least about 50%.

15. The method of claim 12, wherein said deodorized plant fat is selected from a group consisting of coconut, sunflower, sesame, cotton, avocado, grapeseed, nigella seeds and any combination thereof.

16. The method of claim 12, wherein said homogenizing step is conducted by means selected from a group consisting of mixing at about 10000 RPM and pressure homogenization.

17. The method of claim 12, wherein said at least one stabilizer is selected from a group consisting of gellan gum, methyl cellulose, kappa carrageenan, iota carrageenan and any combination thereof.

18. The method of claim 12, wherein said at least one food additive is selected from a group consisting of stabilizers, anticaking agents, antifoaming agents, antioxidants, bulking agents, colorants, emulsifiers, flavoring agents, humectants, preservatives, sweeteners, sugars, starches, minerals, proteins, vitamins, hydrocolloids, thickeners and any combination thereof.
